(19) United States
(12) Patent Application Publication
(10) Pub. No.: US 2015/0180025 A1
(43) Pub. Date: Jun. 25, 2015

(54) Lithium Metal Complex Oxide

(71) Applicant: Mitsui Mining & Smelting Co., Ltd., Tokyo (JP)

(72) Inventors: Tetsuya Mitsumoto, Hiroshima (JP); Hitohiko Ide, Hiroshima (JP); Shinya Kagei, Hiroshima (JP); Yoshimi Hata, Hiroshima (JP)

(21) Appl. No.: 14/413,888

(22) PCT Filed: Jul. 12, 2013
(86) PCT No.: PCT/JP2013/069185

§ 371 Date: Jan. 9, 2015

(30) Foreign Application Priority Data
Jul. 12, 2012 (JP) 2012-156597

(51) Int. Cl. H01M 4/36; H01M 4/505; H01M 4/525; H01M 4/583

(52) U.S. Cl. CPC H01M 4/366; H01M 4/583; H01M 4/505; H01M 4/525

(57) ABSTRACT

Provided is a novel lithium metal complex oxide powder, which is capable of maintaining stability of the slurry viscosity during storage of a slurry even when D50 thereof is less than 10 μm, and which is also capable of suppressing a decrease in the discharge capacity during high temperature cycles. Proposed is a lithium metal complex oxide which is characterized by having a D50 of less than 10 μm and a carbon amount per unit BET specific surface area of from 1100 ppm/(m²/g) to 7500 ppm/(m²/g).

### TECHNICAL FIELD

The present invention relates to a lithium metal complex oxide, which can be used as a positive electrode active material of a lithium battery, and which, in particular, can exhibit excellent performance as a positive electrode material of a battery that is mounted on an electric vehicle (EV) or a hybrid electric vehicle (HEV).

### BACKGROUND ART

Lithium batteries, and among these, lithium secondary batteries, having characteristics such as a large energy density and a long life span, are used widely as power sources for home appliances such as video cameras and portable electronic devices such as notebook computers and mobile phones, and the like. Recently, they have been put into application in large batteries that are mounted on an electric vehicle (EV), a hybrid electric vehicle (HEV) and the like.

A lithium secondary battery is a secondary battery having a structure in which, during charging, lithium dissolves out from the positive electrode as an ion and moves towards the negative electrode to be intercalated and conversely, during discharging, the lithium ion returns from the negative electrode to the positive electrode, and it is known that the high energy density of the battery is based on the electric potential of the positive electrode material.

As a positive electrode material of a lithium secondary battery, lithium metal complex oxides such as LiCoO₂, LiNiO₂ or LiMnO₂ having a layered structure are known in addition to lithium manganese oxides (LiMn₂O₄) having a spinel structure. For example, LiCoO₂ has a layered structure in which a layer of lithium atoms and a layer of cobalt atoms are stacked alternately via a layer of oxygen atoms, and has a large charge-discharge capacity and excellent diffusivity for intercalation and disintercalation of lithium ions. Accordingly, most of the lithium secondary batteries that are commercially available at the present moment have a lithium metal complex oxide like LiCoO₂ with a layered structure.

A lithium metal complex oxide with a layered structure like LiCoO₂ and LiNiO₂ is represented by the general formula LiMeO₂ (Me: transition metal). The crystal structure of the lithium metal complex oxide with a layered structure belongs to space group of R-3m (“-” is usually added on upper part of “3” and represents inversion, and the same shall apply for the followings) and Li ion, Me ion, and oxide ion occupy 3a site, 3b site, and 6c site, respectively. It is also known that the layer consisting of Li ions (Li layer) and the layer consisting of Me ions (Me layer) are stacked alternately via O layer consisting of oxide ions to represent a layered structure.

As a lithium metal complex oxide (LiMₓO₂) with a layered structure, an active material represented by the formula LiNiₓMn₁₋ₓO₂ (in the formula, 0.7≦x≦0.95) which is obtained by adding an alkali solution to an aqueous mixture solution of manganese and nickel to co-precipitate manganese and nickel, adding lithium hydroxide, and subsequently calcining them has been disclosed in Patent Document 1, for example.

Patent Document 2 discloses a positive electrode active material composed of crystal particles of an oxide containing three kinds of transition metals having the layered crystal structure and represented by Li[Liₓ(A_{P}B_{Q}C_{R})₁₋ₓ]O₂ (in the formula, A, B and C respectively means different three kinds of transition metal elements, and −0.1≦x≦0.3, 0.2≦P≦0.4, 0.2≦Q≦0.4, 0.2≦R≦0.4), in which oxygen atom constituting the oxide is arranged for cubic close packing.

In Patent Document 3, for providing laminar lithium nickel manganese complex oxide powder having a high bulk density, disclosed is a method for producing a laminar lithium nickel manganese complex oxide powder in which a slurry containing at least a lithium source compound, a nickel source compound, and a manganese source compound, which are ground and mixed, in a molar ratio [Ni/Mn] of nickel atom [Ni] to manganese atom [Mn] of 0.7 to 9.0 is dried through spray drying and calcined to prepare laminar lithium nickel manganese complex oxide powder, which is then ground.

Patent Document 4 discloses a substance containing lithium transition metal complex oxide obtained by mixing vanadium (V) and/or boron (B) to make a crystallite size large, that is, lithium transition metal complex oxide represented by the general formula: Li_{X}M_{Y}O_{Z-δ} (in the formula, M is Co or Ni as a transition metal element; and relationships (X/Y)=0.98 to 1.02 and (δ/Z)≦0.03 are satisfied) and vanadium (V) and/or boron (B) of ((V+B)/M)=0.001 to 0.05 (molar ratio) with respect to the transition metal element (M) constituting the lithium transition metal complex oxide, and having a primary particle diameter of 1 μm or more, a crystallite size of 450 Å or more, and a lattice distortion of 0.05% or less.

In Patent Document 5, for the purpose of providing a positive electrode active material for a nonaqueous secondary battery consisting of primary particles which can maintain high bulk density or battery characteristics and has no problem of having a crack, disclosed is a positive electrode active material for a nonaqueous secondary battery which is a powdered lithium complex oxide of monodisperse primary particles with lithium and one kind of element selected from a group of Co, Ni, and Mn as main components with D50 of 3 to 12 μm, a specific surface area of 0.2 to 1.0 m²/g, a bulk density of 2.1 g/cm³ or more, and having characteristics of not showing an inflection point of a volume decrease rate by a Cooper Plot method up to 3 ton/cm².

Patent Document 6 relates to powder of lithium metal complex oxide represented by the formula: Li_{z}Ni_{1-w}M_{w}O₂ (provided that, M is at least one metal element selected from the group consisting of Co, Al, Mg, Mn, Ti, Fe, Cu, Zn and Ga, and the relationships 0<w≦25 and 1.0≦z≦1.1 are satisfied), and it discloses a positive electrode active material for a nonaqueous electrolyte secondary battery characterized in that it is composed of primary particles of the lithium metal complex oxide powder and secondary particles formed of a group of plural primary particles in which the shape of the secondary particles are spherical or oval sphere shaped, 95% or more of the secondary particles has a particle diameter of 20 μm or less, an average particle diameter of the secondary particles is 7 to 13 μm, a tap density of the powder is 2.2 g/cm³ or more, an average volume of a pore with an average diameter of 40 nm or less in measurement of a pore size distribution by a nitrogen adsorption method is 0.001 to 0.008 cm³/g, and an average crushing strength of the secondary particles is 15 to 100 MPa.

Patent Document 7 discloses lithium transition metal oxide having a layered structure obtained by grinding with, for example, a wet type grinder or the like until D50 becomes 2 μm or less and performing drying with granulation and calcining by using a heat spray dryer, characterized in that a ratio of the crystallite diameter relative to the average powder particle diameter (D50) as measured by a laser diffraction scattering particle size distribution measurement method is 0.05 to 0.20.

Further, the invention of Patent Document 8 suggests, for preventing a decrease in battery performance as the lithium-containing complex oxide as an electrode material is affected by moisture, to form a coating film consisting of a water-repellent material such as a silane coupling agent on at least one of the surface of lithium-containing complex oxide microparticles and the surface of the positive electrode.

### CITATION LIST

### Patent Document

Patent Document 1: JP H8-171910 A

Patent Document 2: JP 2003-17052 A

Patent Document 3: JP 2003-34536 A

Patent Document 4: JP 2004-253169 A

Patent Document 5: JP 2004-355824 A

Patent Document 6: JP 2007-257985 A

Patent Document 7: JP 4213768 B1 (WO 2008/091028)

Patent Document 8: JP H11-224664 A

### SUMMARY OF THE INVENTION

### Problem to be Solved by the Invention

However, in the case of preparing a positive electrode of a lithium battery by using a lithium metal complex oxide, the lithium metal complex oxide is generally admixed with a conductive material and a binder material consisting of a binder or the like to produce a positive electrode mixture in a slurry state, which is then coated on a conductor for producing a positive electrode. In this case, when the particle size of the lithium metal complex oxide is excessively large, particles are precipitated during storage of the slurry, yielding an non-uniformity state. As such, from such point of view, it can be said that the lithium metal complex oxide preferably has a small particle size, specifically D50 of less than 10 μm.

However, when the lithium metal complex oxide has a particle size (D50) of less than 10 μm, particles of the lithium metal complex oxide aggregate to each other in the slurry to yield lower viscosity stability of slurry during storage of the slurry, and thus the property of coating a current-collecting foil is deteriorated, or due to aggregation of the lithium metal complex oxide (active material), a contact with the conductive material is weakened so that charging and discharging of the active material becomes difficult. As a result, a problem like reduced discharge capacity during high temperature cycles occurs.

Under the circumstances, the present invention, which relates to a lithium metal complex oxide used for a positive electrode of a lithium battery, is to provide a novel lithium metal complex oxide powder which is capable of maintaining stability of the slurry viscosity during storage of a slurry even if the particle size (D50) is less than 10 μm, and which is also capable of suppressing a decrease in the discharge capacity during high temperature cycles.

### Means for Solving Problem

The present invention suggests a lithium metal complex oxide characterized by having D50, which is based on a volume-based particle size distribution as obtained by a laser diffraction scattering particle size distribution measurement method (referred to as “D50”), of less than 10 μm and a carbon amount per unit BET specific surface area of from 1100 ppm/(m²/g) to 7500 ppm/(m²/g).

### Effect of the Invention

It was found that, by attaching organic substances to a surface of a lithium metal complex oxide and adjusting the carbon amount per unit BET specific surface area to the range of from 1100 ppm/(m²/g) to 7500 ppm/(m²/g), hysteresis is suppressed during a shear force response test of a slurry even when the particle size (D50) is less than 10 μm so that stability of the particle dispersion state during storage of a slurry can be maintained, that is to say, stability of the slurry viscosity can be maintained, and also a decrease in discharge capacity during high temperature cycles can be suppressed.

Thus, as the lithium metal complex oxide suggested by the present invention has high affinity to a solvent and excellent dispersability in a slurry, it allows production of an electrode having evenly dispersed active materials, and as a result, it enables an improvement of capacity retention rate during high temperature cycles compared to a product of a related art.

### BRIEF DESCRIPTION OF DRAWINGS

FIG. 1 is a diagram for describing the constitution of a cell for electrochemical evaluation, which is produced for the evaluation of battery characteristics of Examples.

### MODE(S) FOR CARRYING OUT THE INVENTION

Hereinbelow, embodiments of the present invention are described, but by no means the present invention is limited to the following embodiments.

<Present Lithium Metal Complex Oxide>

The lithium metal complex oxide of this embodiment (hereinbelow, referred to as the “present lithium metal complex oxide”) indicates powder having particles of lithium metal complex oxide as a main component (hereinbelow, referred to as “particles of the present lithium metal complex oxide”), in which the lithium metal complex oxide has D50 of less than 10 μm and has a layer containing carbon on a part or the whole of the surface of a particle.

As described herein, unless specifically described otherwise, “as a main component” implies the meaning of allowing other constituents to be contained to such an extent that the functions of the main constituent are not prevented. With regard to the content ratio of the main component, cases in which it occupies 50% by mass or more, particularly 70% by mass or more, of which 90% by mass or more, of which 95% by mass or more (including 100%) of the present lithium metal complex oxide are included.

The present lithium metal complex oxide may contain, as impurities, SO₄ in an amount of 1.0% by mass or less and other elements in an amount of 0.5% by mass or less for each. This is because it is believed that such amount hardly has any influence on the characteristics of the lithium metal complex oxide.

(Particles of Present Lithium Metal Complex Oxide)

The particles of the present lithium metal complex oxide can be either a lithium metal complex oxide with a layered structure or a spinel type (Fd3-m) lithium metal complex oxide. Since the effect of the present invention is mainly based on the influence by a surface layer of particles, it is believed that any of those lithium metal complex oxides can exert the effect.

However, in this section, descriptions are given mostly about the particles of lithium metal complex oxide with a layered structure, which is represented by the general formula (1): Li₁₊ₓM₁₋ₓO₂, as an example of the particles of the present lithium metal complex oxide.

The particles of lithium metal complex oxide with a layered structure mean the particles of lithium metal complex oxide having a layered structure in which a layer of lithium atoms and a layer of transition metal atoms are stacked alternately via a layer of oxygen atoms.

In the above formula (1), “1+x” is 1.00 to 1.07, preferably 1.01 or more or 1.07 or less, and more preferably 1.02 to 1.06.

In the above formula (1), it is sufficient that “M” is any one or more kinds of Mn, Co, Ni, a transition element present between the elements of Group 3 and the elements of Group 11 of the periodic table, and a typical element up to Period 3 of the periodic table.

As described herein, examples of the transition element present between the elements of Group 3 and the elements of Group 11 of the periodic table and the typical element up to Period 3 of the periodic table include Al, V, Fe, Ti, Mg, Cr, Ga, In, Cu, Zn, Nb, Zr, Mo, W, Ta, and Re.

“M” can be any one or more kinds of Mn, Co, Ni, Al, V, Fe, Ti, Mg, Cr, Ga, In, Cu, Zn, Nb, Zr, Mo, W, Ta and Re, and it can be also composed only of three kinds of the elements, that is, Mn, Co and Ni, or may contain one or more kinds of other elements in addition to those three elements. It may also have other constitution.

For a case in which “M” in the formula (1) contains the three elements of Mn, Co and Ni, the molar ratio of the Mn, Co and Ni that are contained is preferably as follows; Mn:Co:Ni=0.10 to 0.45:0.05 to 0.40:0.30 to 0.75. More preferably, it is as follows; Mn:Co:Ni=0.10 to 0.40:0.05 to 0.40:0.30 to 0.75.

For a case in which it is represented by the general formula (2): Li₁₊ₓ(Mn_{α}Co_{β}Ni_{γ})₁₋ₓO₂, those represented by the following ratio are preferable.

In the formula (2), it is preferable that value of α be 0.10 to 0.45, of which 0.15 to 0.40, and in particular 0.20 to 0.35 is more preferable.

It is preferable that value of β be 0.05 to 0.40, of which 0.05 to 0.30, and in particular 0.05 to 0.25 is more preferable.

It is preferable that value of γ be 0.30 to 0.75, of which 0.40 to 0.70, and in particular 0.45 to 0.65 is more preferable.

Meanwhile, although the atomic ratio of an oxygen amount is described as “2” in the general formulae (1) and (2) above for the sake of convenience, it may have rather non-integer ratio.

(D50)

One of the characteristics of the powder of the present lithium metal complex oxide is that D50 based on a volume-based particle size distribution as obtained by a laser diffraction scattering particle size distribution measurement method is less than 10 μm. When D50 of the powder of the present lithium metal complex oxide is less than 10 μm, non-uniformity caused by precipitation of the particles during storage of a slurry can be prevented.

From this point of view, it is preferable that D50 of the powder of the present lithium metal complex oxide be 8 μm or less, of which 7 μm or less, and in particular 4 μm or less is more preferable.

Meanwhile, from the viewpoint of keeping the change rate of a difference in slurry viscosity at low level, it is preferable that D50 of the powder of the present lithium metal complex oxide be 0.5 μm or more, and of which 1 μm or more is particularly preferable.

For adjusting D50 of the powder of the present lithium metal complex oxide to the aforementioned range, it is preferable that D50 adjustment be carried out based on adjustment of D50 of starting materials, adjustment of temperature or time for calcination, or adjustment of D50 by comminuting after the calcination. However, adjustment methods are not limited thereto.

(Surface Layer)

The present lithium metal complex oxide preferably has a surface layer containing carbon on the whole or a part of the surface of a particle.

The surface layer can be formed by a surface treatment using a coupling treatment agent. For example, when a surface layer is formed by a surface treatment using a silane coupling agent, the surface layer contains oxygen, silicon, and carbon. When a surface layer is formed by a surface treatment using a titanium coupling agent, the surface layer contains oxygen, titanium, and carbon. When a surface layer is formed by a surface treatment using an aluminum coupling agent, the surface layer contains oxygen, aluminum, and carbon.

The surface layer may be present such that it can coat the whole surface of the particle of the present lithium metal complex oxide. Alternatively, it may be present partially on the surface such that there is a portion in which the surface is not present. Actually, partial presence of the surface layer on a surface of the particle of the present lithium metal complex oxide to allow direct contact between exposed particle surface and an electrolyte solution is preferred from the viewpoint of suppressing an increase of electric resistance on the particle surface.

(Carbon Amount Per Unit BET Specific Surface Area)

It is preferable that the present lithium metal complex oxide have a carbon amount per unit BET specific surface area of from 1100 ppm/(m²/g) to 7500 ppm/(m²/g), of which 1100 ppm/(m²/g) to 5000 ppm/(m²/g), and particularly 1100 ppm/(m²/g) to 3000 ppm/(m²/g) is more preferable.

With regard to the lithium metal complex oxide, even when the particle size (D50) is less than 10 μm, by attaching organic substances to a surface of the particles and having a carbon amount per unit BET specific surface area of from 1100 ppm/(m²/g) or more, an increase in slurry viscosity can be suppressed. Accordingly, hysteresis can be suppressed during the evaluation of a slurry and also a decrease in discharge capacity during high temperature cycles can be suppressed.

However, when the amount of the organic substances attached thereto is excessively high, electric resistance may occur on a surface of the particles during charging and discharging. From this point of view, it is preferably 7500 ppm/(m²/g) or less, of which 5000 ppm/(m²/g) or less, and particularly 3000 ppm/(m²/g) or less is more preferable.

To adjust the carbon amount per unit BET specific surface area to the aforementioned range, a surface treatment using a suitable amount of a coupling agent may be carried out for the lithium metal complex oxide obtained by comminuting or grinding after calcination.

(Crushing Strength of Powder)

The minimum value of the crushing strength of powder, which is obtained by crushing powder using a micro crushing tester, of the powder of the present lithium metal complex oxide is preferably more than 70 MPa.

When the minimum value of the crushing strength of the powder of the present lithium metal complex oxide is more than 70 MPa, disintegration of the particles can be suppressed even when it is used as a positive electrode material of a lithium secondary battery and expansion and contraction of the positive electrode material occur during charging and discharging of the lithium secondary battery. As a result, the capacity retention rate, particularly during high temperature cycles, can be further enhanced.

From this point of view, it is preferable that the minimum value of the crushing strength of the powder of the present lithium metal complex oxide be more than 70 MPa, of which more than 75 MPa, in particular more than 80 MPa, and even in particular more than 85 MPa is more preferable.

To adjust the minimum value of the crushing strength of the powder of the present lithium metal complex oxide to the aforementioned range, for a production method based on a spray drying which is described below, for example, the minimum value of the crushing strength of the powder can be adjusted to a value more than 70 MPa by reducing the size of D50 based on stronger comminuting after calcination or heat treatment compared to a conventional technique.

Meanwhile, for a production method based on co-precipitation which is described below, compared to a conventional technique, for example, the temperature for calcination is lowered, the average particle diameter of primary particles of co-precipitated powder is reduced, calcination under atmosphere of carbon dioxide is performed to make the average particle diameter of primary particles small, whereby the minimum value of the crushing strength of the powder can be adjusted to a value more than 70 Mpa.

However, adjustment methods are not limited thereto.

(Production Method)

Next, descriptions are given for the method of producing the powder of the present lithium metal complex oxide.

The powder of the present lithium metal complex oxide can be obtained as follows, for example. Raw materials like a lithium salt compound, a manganese salt compound, a nickel salt compound, and a cobalt salt compound are weighed, admixed with one another, and ground by using a wet type grinder or the like followed by granulation, calcination, and as necessary, a heat treatment. Then, they are comminuted under desirable conditions, and as necessary, subjected to classification, and then surface-treated by using a coupling agent or the like.

Examples of the lithium salt compound as a raw material include lithium hydroxide (LiOH), lithium carbonate (Li₂CO₃), lithium nitrate (LiNO₃), LiOH.H₂O, lithium oxide (Li₂O), and other lithium fatty acid and lithium halide. Among them, hydroxide salt, carbonate salt, and nitrate salt of lithium are preferable.

The type of the manganese salt compound is not particularly limited. Examples thereof which may be used include manganese carbonate, manganese nitrate, manganese chloride, and manganese dioxide. Among them, manganese carbonate and manganese dioxide are preferable. Among them, electrolytic manganese dioxide obtained by an electrolytic method is particularly preferable.

The type of the nickel salt compound is not particularly limited. Examples thereof which may be used include nickel carbonate, nickel nitrate, nickel chloride, nickel oxyhydroxide, nickel hydroxide, and nickel oxide. Among them, nickel carbonate, nickel hydroxide, and nickel oxide are preferable.

The type of the cobalt salt compound is not particularly limited. Examples thereof which may be used include basic cobalt carbonate, cobalt nitrate, cobalt chloride, cobalt oxyhydroxide, cobalt hydroxide, and cobalt oxide. Among them, basic cobalt carbonate, cobalt hydroxide, cobalt oxide, and cobalt oxyhydroxide are preferable.

Mixing of the raw materials is preferably performed by adding a liquid medium like water or a dispersing agent and performing wet mixing to yield a slurry. When a spray drying method which is described below is employed, it is preferable that the slurry obtained be ground by using a wet type grinder. However, dry type grinding is also employed.

As long as the various raw materials that were ground in the previous step do not separate and are dispersed in the granulation particles, the granulation method may be either wet or dry granulation method, or may be extrusion granulation method, tumbling granulation method, fluidized bed granulation method, mixing granulation method, spray drying granulation method, compression molding granulation method, or flake granulation method using a roll or the like. However, if wet granulation is performed, drying thoroughly prior to calcination is necessary. As for the drying methods, it is sufficient that the drying is performed by a well-known method such as spray heat drying method, hot air drying method, vacuum drying method and freeze-drying method, among which the spray heat drying method is desirable. It is desirable to perform the spray heat drying method using a heat spray dryer (spray dryer) (in the present specification, it is referred to as a “spray drying method”).

Meanwhile, it is also possible to produce, by a so-called co-precipitation method, co-precipitated powder to be provided to calcination (in the present specification, it is referred to as a “co-precipitation method”). According to the co-precipitation method, co-precipitated powder can be obtained by dissolving raw materials in a solution and precipitating them by controlling conditions like pH.

Meanwhile, according to the spray drying method, there is a tendency that voids are generated among the particles due to relatively low powder strength. Accordingly, for a case of using the spray drying method, it is preferable that the comminution strength be increased compared to the comminution method of a related art, for example, a comminution method using a rough grinder having the revolution number of 1000 rpm or so. For example, by reducing D50 based on increased comminution strength by comminuting using a high speed rotary grinder or the like, it is preferably adjusted to be in the range defined by the present invention.

Meanwhile, in the co-precipitation method, the primary particles tend to be large. Accordingly, for a case of employing the co-precipitation method, it is preferable that the calcination temperature be lowered, calcination time be shortened, or primary particle size of the co-precipitated powder be reduced compared to a common co-precipitation method of a related art, or calcination be performed under carbon dioxide atmosphere or the like so that the average particle diameter of the primary particles is reduced and adjusted to be in the range defined by the present invention.

It is preferable that calcination be carried out in a calcination furnace under air atmosphere, under oxygen gas atmosphere, under an atmosphere with the oxygen partial pressure adjusted, or under carbon dioxide gas atmosphere, or under other atmosphere, with calcination conditions in which a temperature of higher than 800° C. but lower than 1000° C. (: meaning the temperature when a thermocouple is brought into contact with the calcination object inside the calcination furnace), preferably 810 to 1000° C., and more preferably 810 to 950° C. for 0.5 to 30 hours is maintained. At that time, the calcination conditions are preferably selected such that the transition metals are present as solid-solution at an atomic level to exhibit a single phase.

There is no particular limitation on the type of calcination furnace. For example, a rotary kiln, a stationary furnace and other calcination furnaces can be used to perform calcination.

The heat treatment after the calcination is preferably performed when adjustment of a crystal structure is needed. The heat treatment may be performed under an oxidizing atmosphere like under air atmosphere, under oxygen gas atmosphere, under an atmosphere with the oxygen partial pressure adjusted, or the like.

Crushing after calcination or heat treatment is preferably performed by crushing using a high speed rotary grinder as described above. When crushing is performed by using a high speed rotary grinder, aggregated particles or weakly calcined portions can be crushed and also an occurrence of a deformation of the particles can be suppressed. However, it is not limited to a high speed rotary grinder.

Examples of the high speed rotary grinder include a pin mill. A pin mill is known as a rotary disc type grinder and it is a crusher with a working mode in which negative internal pressure is created according to rotation of a rotary disc attached with pins and powder is suctioned in from an inlet for raw materials. Accordingly, fine particles having small weight are easily carried by air flow and pass through a clearance within a pin mill. On the other hand, coarse particles are certainly crushed. For such reasons, not only the aggregated particles or weakly calcined portions can be certainly crushed but also an occurrence of a deformation of the particles can be suppressed using a pin mill.

The revolution number of the high speed rotary grinder is 4000 rpm or more, preferably 5000 to 12000 rpm, and more preferably 7000 to 10000 rpm.

Classification after calcination has a technical meaning of particle size distribution adjustment of cohesive powders and also removal of impurities. Thus, classification is preferably carried out by selecting a sieve with a desired size.

The surface treatment after calcination is preferably performed by a surface treatment of the lithium metal complex oxide by using a coupling agent, or the like.

It is sufficient that the silane coupling agent as an example of a coupling agent is an organosilicon compound having an organic functional group and a hydrolyzable group in the molecule. In particular, those containing an organosilicon compound which has an amino group in the side chain are preferable. Specific examples thereof include tetramethoxysilane, tetraethoxysilane, decyltrimethoxysilane, and glycidoxypropyltrimethoxysilane.

Further, it is also possible to use an aluminate-based coupling agent or a titanate-based coupling agent other than the silane coupling agent.

When a surface treatment of the lithium metal complex oxide is performed by using such a coupling agent, it is preferable to perform drying by heating to evaporate the solvent. At that time, the temperature is preferably set to 40 to 200° C.

The ratio of an addition amount of a solvent (mass) relative to the mass of the coupling agent is 0.1 to 10, of which 0.1 to 5, and particularly 0.1 to 3 is preferable. As the addition amount of a solvent (mass) relative to the mass of the coupling agent is 0.1 to 10, not only the surface coating rate can be easily adjusted but also the solvent can be easily evaporated, and thus preferable.

(Characteristics•Applications)

After being crushed and classified as necessary, the powder of the present lithium metal complex oxide can be used effectively as a positive electrode active material of a lithium battery.

For example, a positive electrode mixture in slurry state can be prepared by mixing the powder of the present lithium metal complex oxide, a conducting material consisting of carbon black or the like and a binder consisting of Teflon (registered trade mark of DuPont, USA) binder or the like. Then, such a positive electrode mixture can be used for the positive electrode, lithium or a material capable of intercalating and disintercalating lithium, such as carbon, can be used for the negative electrode, and a lithium salt such as lithium hexafluophosphate (LiPF₆) dissolved in a mixed solvent such as ethylenecarbonate-dimethylcarbonate can be used for the non-aqueous electrolyte to construct a lithium secondary battery. However, a battery is not limited to such a constitution.

A lithium battery having the powder of the present lithium metal complex oxide as a positive electrode active material can exhibit excellent life characteristics (cycle characteristics) when used for charging and discharging repeatedly, and thus it is particularly excellent for applications in positive electrode active material of a lithium battery which is used as a power source to drive motors mounted in an electric vehicle (EV) or a hybrid electric vehicle (HEV).

Meanwhile, the “hybrid vehicle” means a vehicle that combines the use of two power sources, that is, an electric motor and an internal combustion engine.

In addition, the “lithium battery” is meant to include all batteries containing lithium or lithium ion inside the battery, such as a lithium primary battery, a lithium secondary battery, a lithium ion secondary battery, or a lithium polymer battery.

<Explanations of Terminology>

In the present specification, when the expression “X to Y” (X and Y are any numbers) is used, unless explicitly mentioned otherwise, the meaning of “X or more but Y or less” is included and at the same time the meaning of “preferably more than X” or “preferably less than Y” is included.

In addition, the expression “X or more” (X is any number) or “Y or less” (Y is any number) also includes the meaning of “more than X is preferable” or “less than Y is preferable”.

### EXAMPLES

Next, the present invention is described further based on Examples and Comparative Examples, but the present invention is not limited to Examples that are given below.

### Example 1

Ammonium salt of polycarboxylic acid (SN DISPERSANT 5468, manufactured by San Nopco Limited) was added as a dispersant to ion exchange water such that it corresponds to 6% by mass of the solid content in the slurry and the dispersant was fully dissolved and mixed in ion exchange water.

Lithium carbonate with D50: 7 μm, electrolytic manganese dioxide with D50: 23 μm and a specific surface area of 40 m²/g, cobalt oxyhydroxide with D50: 14 μm, and nickel hydroxide with D50: 22 μm were weighed such that they have a molar ratio of Li:Mn:Ni:Co=1.04:0.26:0.51:0.19. Then, to the aforementioned ion exchange water in which a dispersant is dissolved in advance, they were added in the above-described order followed by mixing under stirring to prepare a slurry with a solid content of 50% by mass. By using a wet type grinder, it was ground at 1300 rpm for 40 minutes to have D50 of 0.5 μm.

The obtained ground slurry was granulated and dried using a heat spray dryer (spray dryer i-8, manufactured by Ohkawara Kakohki Co., Ltd.). In so doing, granulation-drying was carried out using a rotary disc for spraying, at the revolution number of 24,000 rpm, a slurry supply amount of 3 kg/hr, and a drying tower exit temperature adjusted to 100° C.

The obtained granulated powder was subjected to temporary calcination at 450° C. in air by using a stationary electric furnace. Subsequently, powder obtained after temporary calcination was calcined at 910° C. for 20 hours by using a stationary electric furnace.

The calcined mass obtained after calcination was added to a mortar and crushed using a pestle. It was sifted through a sieve with a mesh size of 5 mm and those passed through the sieve were crushed by using a high speed rotary grinder (pin mill, manufactured by Makino Mfg. Co., Ltd.) (condition for crushing: revolution number of 10000 rpm) followed by classification using a sieve with a mesh size of 53 μm. Then, the powder of lithium metal complex oxide passed through the sieve was collected.

As a result of performing chemical analysis of the collected powder of lithium metal complex oxide, it was found to be Li_{1.04}Ni_{0.52}Co_{0.19}Mn_{0.25}O₂.

Furthermore, 99 parts by mass of the powder of lithium metal complex oxide, 0.5 parts by mass of n-octyl trimethoxysilane as a surface treatment agent, and 0.5 parts by mass of methanol as a solvent were admixed with one another by using a cutter mill (“Millser 720G”, manufactured by Iwatani Corporation) and subjected to a heat treatment at 140° C. in air for 1 hour. As a result, surface-treated powder of lithium metal complex oxide (sample) was obtained.

### Example 2

Surface-treated powder of lithium metal complex oxide (sample) was prepared in the same manner as in Example 1, except that powder of lithium metal complex oxide was prepared in the same manner as in Example 1 and 99 parts by mass of the powder of lithium metal complex oxide, 1 part by mass of n-octyl trimethoxysilane as a surface treatment agent, and 1 part by mass of methanol as a solvent were used and admixed with one another.

### Example 3

Surface-treated powder of lithium metal complex oxide (sample) was prepared in the same manner as in Example 1, except that powder of lithium metal complex oxide was prepared in the same manner as in Example 1 and 97 parts by mass of the powder of lithium metal complex oxide, 2 parts by mass of n-octyl trimethoxysilane as a surface treatment agent, and 1 part by mass of methanol as a solvent were used and admixed with one another.

### Example 4

Ammonium salt of polycarboxylic acid (SN DISPERSANT 5468, manufactured by San Nopco Limited) was added as a dispersant to ion exchange water such that it corresponds to 6% by mass of the solid content in the slurry and the dispersant was fully dissolved and mixed in ion exchange water.

Lithium carbonate with D50: 7 μm, electrolytic manganese dioxide with D50: 23 μm and a specific surface area of 40 m²/g, cobalt oxyhydroxide with D50: 14 μm, and nickel hydroxide with D50: 22 μm were weighed such that they have a molar ratio of Li:Mn:Ni:Co=1.04:0.26:0.51:0.19. Then, to the aforementioned ion exchange water in which a dispersant is dissolved in advance, they were added in the above-described order followed by mixing under stirring to prepare a slurry with a solid content of 50% by mass. By using a wet type grinder, it was ground at 1300 rpm for 40 minutes to have D50 of 0.5 μm.

The obtained ground slurry was granulated and dried using a heat spray dryer (spray dryer i-8, manufactured by Ohkawara Kakohki Co., Ltd.). In so doing, granulation-drying was carried out using a rotary disc for spraying, at the revolution number of 24,000 rpm, a slurry supply amount of 3 kg/hr, and a drying tower exit temperature adjusted to 100° C.

The obtained granulated powder was subjected to temporary calcination at 450° C. in air by using a stationary electric furnace. Subsequently, powder obtained after temporary calcination was calcined at 910° C. for 20 hours by using a stationary electric furnace.

The calcined mass obtained after calcination was added to a mortar and crushed using a pestle. It was sifted through a sieve with a mesh size of 53 μm. Then, the powder of lithium metal complex oxide passed through the sieve was collected.

The collected complex oxide powder was ground by using a collision type grinder having a classifying device (counted jet mill “100AFG/50ATP”, manufactured by Hosokawa Micron Corporation) at conditions including revolution number of rotor for classification: 14900 rpm, air pressure for grinding: 0.6 MPa, grinder nozzle φ: 2.5, three nozzles were used, and supply amount of powder: 4.5 kg/h to obtain powder of lithium metal complex oxide.

As a result of performing chemical analysis of the obtained powder of lithium metal complex oxide (sample), it was found to be Li_{1.04}Ni_{0.52}Co_{0.19}Mn_{0.25}O₂.

Furthermore, 99 parts by mass of the powder of lithium metal complex oxide, 0.5 parts by mass of n-octyl trimethoxysilane as a surface treatment agent, and 0.5 parts by mass of methanol as a solvent were admixed with one another by using a cutter mill (“Millser 720G”, manufactured by Iwatani Corporation) and subjected to a heat treatment at 140° C. in air for 1 hour. As a result, surface-treated powder of lithium metal complex oxide (sample) was obtained.

### Example 5

Surface-treated powder of lithium metal complex oxide (sample) was prepared in the same manner as in Example 4, except that powder of lithium metal complex oxide was prepared in the same manner as in Example 4 and 98 parts by mass of the powder of lithium metal complex oxide, 1 part by mass of n-octyl trimethoxysilane as a surface treatment agent, and 1 part by mass of methanol as a solvent were used and admixed with one another.

### Example 6

Surface-treated powder of lithium metal complex oxide (sample) was prepared in the same manner as in Example 4, except that powder of lithium metal complex oxide was prepared in the same manner as in Example 4 and 97 parts by mass of the powder of lithium metal complex oxide, 2 parts by mass of n-octyl trimethoxysilane as a surface treatment agent, and 1 part by mass of methanol as a solvent were used and admixed with one another.

### Example 7

Surface-treated powder of lithium metal complex oxide (sample) was prepared in the same manner as in Example 4, except that powder of lithium metal complex oxide was prepared in the same manner as in Example 4 and 98 parts by mass of the powder of lithium metal complex oxide, 1 part by mass of 3-glycidoxypropyl trimethoxysilane as a surface treatment agent, and 1 part by mass of methanol as a solvent were used and admixed with one another, and the heat treatment was performed for 1 hour at 100° C. in air.

### Example 8

Surface-treated powder of lithium metal complex oxide (sample) was prepared in the same manner as in Example 4, except that powder of lithium metal complex oxide was prepared in the same manner as in Example 4, 94 parts by mass of the powder of lithium metal complex oxide, 3 parts by mass of 3-glycidoxypropyl trimethoxysilane as a surface treatment agent, and 3 parts by mass of methanol as a solvent were used and admixed with one another, and the heat treatment was performed for 1 hour at 100° C. in air.

### Example 9

Surface-treated powder of lithium metal complex oxide (sample) was prepared in the same manner as in Example 4, except that powder of lithium metal complex oxide was prepared in the same manner as in Example 4, 90 parts by mass of the powder of lithium metal complex oxide, 5 parts by mass of 3-glycidoxypropyl trimethoxysilane as a surface treatment agent, and 5 parts by mass of methanol as a solvent were used and admixed with one another, and the heat treatment was performed for 1 hour at 100° C. in air.

### Example 10

Surface-treated powder of lithium metal complex oxide (sample) was prepared in the same manner as in Example 1, except that powder of lithium metal complex oxide was prepared in the same manner as in Example 1, 98 parts by mass of the powder of lithium metal complex oxide, 1 part by mass of aluminate-containing coupling agent (PLENACT (registered mark) AL-M, manufactured by Ajinomoto Fine-Techno Co., Inc.) as a surface treatment agent, and 1 part by mass of isopropyl alcohol as a solvent were used and admixed with one another, and the heat treatment was performed for 1 hour at 100° C. in air.

### Example 11

Surface-treated powder of lithium metal complex oxide (sample) was prepared in the same manner as in Example 1, except that powder of lithium metal complex oxide was prepared in the same manner as in Example 1, 98 parts by mass of the powder of lithium metal complex oxide, 1 part by mass of titanate-containing coupling agent (PLENACT KR-46B, manufactured by Ajinomoto Fine-Techno Co., Inc.) as a surface treatment agent, and 1 part by mass of isopropyl alcohol as a solvent were used and admixed with one another, and the heat treatment was performed for 1 hour at 100° C. in air.

### Example 12

Surface-treated powder of lithium metal complex oxide (sample) was prepared in the same manner as in Example 1, except that powder of lithium metal complex oxide was prepared in the same manner as in Example 1, 98 parts by mass of the powder of lithium metal complex oxide, 1 part by mass of 3-glycidoxypropyl trimethoxysilane as a surface treatment agent, and 1 part by mass of methanol as a solvent were used and admixed with one another, and the heat treatment was performed for 1 hour at 100° C. in air.

### Comparative Example 1

Ammonium salt of polycarboxylic acid (SN DISPERSANT 5468, manufactured by San Nopco Limited) was added as a dispersant to ion exchange water such that it corresponds to 6% by mass of the solid content in the slurry and the dispersant was fully dissolved and mixed in ion exchange water.

Lithium carbonate with D50: 7 μm, electrolytic manganese dioxide with D50: 23 μm and a specific surface area of 40 m²/g, cobalt oxyhydroxide with D50: 14 μm, and nickel hydroxide with D50: 22 μm were weighed such that they have a molar ratio of Li:Mn:Ni:Co=1.04:0.26:0.51:0.19. Then, to the aforementioned ion exchange water in which a dispersant is dissolved in advance, they were added in the above-described order followed by mixing under stirring to prepare a slurry with a solid content of 50% by mass. By using a wet type grinder, it was ground at 1300 rpm for 40 minutes to have D50 of 0.5 μm.

The obtained ground slurry was granulated and dried using a heat spray dryer (spray dryer i-8, manufactured by Ohkawara Kakohki Co., Ltd.). In so doing, granulation-drying was carried out using a rotary disc for spraying, at the revolution number of 24,000 rpm, a slurry supply amount of 3 kg/hr, and a drying tower exit temperature adjusted to 100° C.

The obtained granulated powder was subjected to temporary calcination at 450° C. in air by using a stationary electric furnace. Subsequently, powder obtained after temporary calcination was calcined at 910° C. for 20 hours by using a stationary electric furnace.

The calcined mass obtained after calcination was added to a mortar and crushed using a pestle. It was sifted through a sieve with a mesh size of 5 mm and those passed through the sieve were crushed by using a high speed rotary grinder (pin mill, manufactured by Makino Mfg. Co., Ltd.) (condition for crushing: revolution number of 10000 rpm) followed by classification using a sieve with a mesh size of 53 μm. Then, the powder of lithium metal complex oxide (sample) passed through the sieve was collected.

As a result of performing chemical analysis of the collected powder of lithium metal complex oxide (sample), it was found to be Li_{1.04}Ni_{0.52}Co_{0.19}Mn_{0.25}O₂.

### Comparative Example 2

Ammonium salt of polycarboxylic acid (SN DISPERSANT 5468, manufactured by San Nopco Limited) was added as a dispersant to ion exchange water such that it corresponds to 6% by mass of the solid content in the slurry and the dispersant was fully dissolved and mixed in ion exchange water.

Lithium carbonate with D50: 7 μm, electrolytic manganese dioxide with D50: 23 μm and a specific surface area of 40 m²/g, cobalt oxyhydroxide with D50: 14 μm, and nickel hydroxide with D50: 22 μm were weighed such that they have a molar ratio of Li:Mn:Ni:Co=1.04:0.26:0.51:0.19. Then, to the aforementioned ion exchange water in which a dispersant is dissolved in advance, they were added in the above-described order followed by mixing under stirring to prepare a slurry with a solid content of 50% by mass. By using a wet type grinder, it was ground at 1300 rpm for 40 minutes to have D50 of 0.5 μm.

The obtained ground slurry was granulated and dried using a heat spray dryer (spray dryer i-8, manufactured by Ohkawara Kakohki Co., Ltd.). In so doing, granulation-drying was carried out using a rotary disc for spraying, at the revolution number of 24,000 rpm, a slurry supply amount of 3 kg/hr, and a drying tower exit temperature adjusted to 100° C.

The obtained granulated powder was subjected to temporary calcination at 450° C. in air by using a stationary electric furnace. Subsequently, powder obtained after temporary calcination was calcined at 910° C. for 20 hours by using a stationary electric furnace.

The calcined mass obtained after calcination was added to a mortar and crushed using a pestle. It was sifted through a sieve with a mesh size of 53 μm. Then, the powder of lithium metal complex oxide passed through the sieve was collected.

The collected complex oxide powder was ground by using a collision type grinder having a classifying device (counted jet mill “100AFG/50ATP”, manufactured by Hosokawa Micron Corporation) at conditions including revolution number of rotor for classification: 14900 rpm, air pressure for grinding: 0.6 MPa, grinder nozzle φ: 2.5, three nozzles were used, and supply amount of powder: 4.5 kg/h to obtain powder of lithium metal complex oxide (sample).

As a result of performing chemical analysis of the obtained powder of lithium metal complex oxide (sample), it was found to be Li_{1.04}Ni_{0.52}Co_{0.19}Mn_{0.25}O₂.

<Measurement of Carbon Amount>

The content of carbon (C) in the powder of lithium metal complex oxide which has been obtained from each of Examples and Comparative Examples (sample) was measured by using an apparatus for analyzing carbon in solid (EMIA-110, manufactured by HORIBA, Ltd.) with oxygen as carrier gas and a gas pressure of 0.75±0.05 kgf/cm², and standard setting conditions described in the manuals for EMIA-110. Meanwhile, for a sample at high concentration, the sample amount was suitably reduced so as not to have scale over.

<Specific Surface Area: BET>

For the powder of lithium metal complex oxide (sample) which has been obtained from each of Examples and Comparative Examples, 0.5 g of sample (powder) was weighed in a glass cell for MONOSORB LOOP (manufactured by Yuasa Ionics Inc., product name “MS-18”), a specific surface area measurement device by the flow gas adsorption method, the inside of the glass cell was replaced with nitrogen gas for 5 minutes with a gas amount of 30 mL/min using a pretreatment device for the MONOSORB LOOP, and then the heat treatment was carried out at 250° C. for 10 minutes in the above nitrogen gas atmosphere. Thereafter, the sample (powder) was measured by the BET one point method using the MONOSORB LOOP.

Note that the adsorption gas used during the measurement was a mixture gas of 30% nitrogen:70% helium.

<Measurement of D50>

For the powder of lithium metal complex oxide (sample) which has been obtained from each of Examples and Comparative Examples, using an automatic sample supplier (“Microtorac SDC” manufactured by Nikkiso Co., Ltd.) for a device for laser diffraction particle diameter distribution measurement, the sample (powder) was introduced to a water soluble solvent, and while at a flow rate of 40%, 40 watts ultrasound was applied for 360 seconds. Then, the particle size distribution was measured using a laser diffraction particle size distribution analyzer “MT3000II” manufactured by Nikkiso Co., Ltd. Then, D50 was obtained from the obtained chart of volume-based particle size distribution.

Meanwhile, ethanol was used as a water soluble solvent for the measurement, the solvent refractive index was 1.36, the particle transmitting condition was set at transmitting, the particle refractive index was 2.46, the shape was non-spherical, the measurement range was 0.133 to 704.0 μm, and the measurement time was 30 seconds. The mean value from two measurements was used as D50.

<Measurement of Powder Crushing Strength>

The powder of lithium metal complex oxide (sample) which has been obtained from each of Examples and Comparative Examples was subjected to measurement of crushing strength (MPa) using a micro crushing tester (manufactured by Shimadzu Corporation), in which ten measurements of the crushing strength were made for each of the secondary particle with D50±2 μm according to the volume-based particle size distribution. Among the ten measurement values, the minimum value was taken as the minimum crushing strength of particle (MPa).

<Method for Evaluation of Shear Stress and Slurry Viscosity>

8.0 g of the powder of lithium metal complex oxide (sample) which has been obtained from each of Examples and Comparative Examples, 0.6 g of acetylene black (manufactured by DENKI KAGAKU KOGYO KABUSHIKI KAISHA), and 5 g of liquid containing PVDF (manufactured by Kishida Chemical Co., Ltd.) dissolved at a concentration of 12% by mass in NMP (N-methyl pyrrolidone) were precisely weighed followed by addition of 6 mL of NMP. After sufficient mixing, a slurry was prepared.

The slurry which has been prepared as described above was evaluated by using the slurry analyzer RheoStress600 (manufactured by Thermo HAAKE). Namely, the slurry was placed between two plates, that is, the top and bottom plates, and the top part was rotated and the revolution number was continuously increased to 1000 [1/s]. Then, the slurry viscosity 1 [Pas] when the shear rate is 100 [1/s] was obtained. Further, the revolution number was continuously reduced to 0 [1/s] and the slurry viscosity 2 [Pas] when the shear rate is 100 [1/s] was obtained. Then, the difference between the slurry viscosity 1 [Pas] and the slurry viscosity 2 [Pas] was measured for each sample, and the resulting value was used as A.

The difference in slurry viscosity was also measured in the same manner as above for the slurry which has been stored for 3 days at 25° C. and 30%, and the resulting value was used as B.

From the aforementioned A and B, the change rate (%) of difference in slurry viscosity was calculated.

Change rate (%) of difference in slurry viscosity=(B−A/A)×100

Further, in Table 1, the change rate (%) of difference in slurry viscosity of each Example and Comparative Example was described as a relative value (%) when the change rate (%) of difference in slurry viscosity of Comparative Example 1 is set at 100(%).

<Evaluation of Battery Characteristics>

A paste was prepared by weighing accurately 8.0 g of the powder of lithium metal complex oxide (sample) which has been obtained from each of Examples and Comparative Examples, 1.0 g of acetylene black (manufactured by DENKI KAGAKU KOGYO KABUSHIKI KAISHA) and 8.3 g of a solution containing PVDF (manufactured by Kishida Chemical Co., Ltd.) dissolved at a concentration of 12% by mass in NMP (N-methyl pyrrolidone), adding thereto 5 ml of NMP and mixing thoroughly. This paste was placed on an aluminum foil which serves as a current collector, prepared as a coating film by using an applicator adjusted to a gap of 100 μm to 280 μm, vacuum-dried overnight at 140° C., then, punched with 16 mmφ, and compressed by pressing at 4 t/cm² to be turned into a positive electrode.

Immediately prior to battery fabrication, the adsorbed moisture was removed by vacuum drying at 120° C. for 120 minutes or longer, and fitted into the battery. In addition, the mean value of the weights of the 16 mmφ aluminum foils was determined in advance and the weight of the aluminum foil was subtracted from the weight of the positive electrode to determine the weight of the positive electrode mixture. Furthermore, the content of the positive electrode active material was determined from the mixing ratios of the powder of lithium metal complex oxide (positive electrode active material), acetylene black, and PVDF.

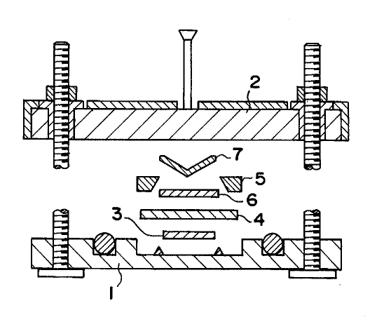

The negative electrode was a 19 mmφ×0.5 mm thick metallic Li, and the electrolytic solution used was LiPF₆ dissolved as a solute at 1 mol/L in a solvent of EC and DMC that are admixed with each other at volume ratio of 3:7. As a result, TOMCELL (registered trade mark), which is a cell for electrochemical evaluation, illustrated in FIG. 1 was fabricated.

(Evaluation of High Temperature Cycle Life Characteristics: 60° C. High Temperature Cycle Characteristics)

The electrochemical cell after the evaluation of initial charging and discharging efficiency as described above was subjected to a charging and discharging test and the high temperature cycle life characteristics was evaluated by the methods described below.

A cell was placed in an environment tester which was set in such a way that the ambient temperature at which the battery is charged and discharged was at 60° C., the cell was prepared so that it could be charged and discharged, left for 4 hours so that the cell temperature reaches the ambient temperature, then, one cycle of charging and discharging was performed with the charging and discharging range of 3.0 V to 4.3 V in which charging uses 0.1 C constant current and constant voltage and discharging uses 0.1 C constant current. Thereafter, the charging and discharging cycle was performed 50 times at 1 C.

The percentage (%) of the value determined by dividing the discharge capacity at the 51st cycle by the discharge capacity at the 2nd cycle was obtained as the value for high temperature cycle life characteristics.

In Table 1, the value for high temperature cycle life characteristics from each Example and Comparative Example was described as a relative value (%) when the value for high temperature cycle life characteristics of Comparative Example 1 is set at 100(%).

TABLE 1

| | | Example 1 | Example 2 | Example 3 | Example 4 | Example 5 | Example 6 | Example 7 | Example 8 |
|---|---|---|---|---|---|---|---|---|---|
| D50 | μm | 7 | 7 | 7 | 2 | 2 | 2 | 2 | 2 |
| Carbon | ppm | 1100 | 2500 | 2600 | 2400 | 3400 | 3500 | 4160 | 8125 |
| BET | m²/g | 0.8 | 1.0 | 0.9 | 2.1 | 1.9 | 1.9 | 2.0 | 2.0 |
| Carbon | ppm/ | 1375 | 2500 | 2889 | 1143 | 1789 | 1842 | 2080 | 4063 |
| amount/BET | (m²/g) | | | | | | | | |
| Powder | MPa | 76 | 76 | 77 | 85 | 89 | 91 | 92 | 90 |
| crushing | | | | | | | | | |
| strength | | | | | | | | | |
| Change rate | % | 13 | 17 | 29 | 56 | 87 | 70 | 41 | 35 |
| of | | | | | | | | | |
| difference | | | | | | | | | |
| in slurry | | | | | | | | | |
| viscosity | | | | | | | | | |
| 60° C. Cycle | % | 104 | 108 | 107 | 115 | 113 | 116 | 118 | 117 |
| evaluation | | | | | | | | | |
| (Negative | | | | | | | | | |
| electrode | | | | | | | | | |
| Li) | | | | | | | | | |
| Capacity | | | | | | | | | |
| retention | | | | | | | | | |
| rate after | | | | | | | | | |
| 50 cycles | | | | | | | | | |

| | | | | | | Comparative | Comparative |
|---|---|---|---|---|---|---|---|
| | | Example 9 | Example 10 | Example 11 | Example 12 | Example 1 | Example 2 |
| D50 | μm | 2 | 7 | 7 | 7 | 7 | 2 |
| Carbon | ppm | 13530 | 5935 | 2920 | 4645 | 900 | 600 |
| BET | m²/g | 2.0 | 1.0 | 1.0 | 1.0 | 0.9 | 1.9 |
| Carbon | ppm/ | 6765 | 5935 | 2920 | 4645 | 1000 | 421 |
| amount/BET | (m²/g) | | | | | | |
| Powder | MPa | 86 | 78 | 77 | 78 | 75 | 84 |
| crushing | | | | | | | |
| strength | | | | | | | |
| Change rate | % | 36 | 10 | 30 | 24 | 100 | 156 |
| of | | | | | | | |
| difference | | | | | | | |
| in slurry | | | | | | | |
| viscosity | | | | | | | |
| 60° C. Cycle | % | 113 | 105 | 103 | 105 | 100 | 114 |
| evaluation | | | | | | | |
| (Negative | | | | | | | |
| electrode | | | | | | | |
| Li) | | | | | | | |
| Capacity | | | | | | | |
| retention | | | | | | | |
| rate after | | | | | | | |
| 50 cycles | | | | | | | |

(Discussions)

Even with the lithium metal complex oxide having a particle size (D50) of less than 10 μm, by attaching organic substances to a surface of the particles and having a carbon amount per unit BET specific surface area of 1100 ppm/(m²/g) or more, the affinity to a solvent can be increased and dispersability in a slurry can be improved. As such, an increase in slurry viscosity can be suppressed and thus hysteresis can be suppressed during the evaluation of a slurry and also a decrease in discharge capacity during high temperature cycles can be suppressed. However, when the amount of the organic substances is excessively high on a particle surface, an increased electric resistance on a surface of the particle may be caused during charging and discharging. As such, it is believed that the amount of carbon per unit BET specific surface area is preferably 7500 ppm/(m²/g) or less.

It is believed that the aforementioned effect is mainly based on the influence of a surface layer and it is not greatly affected by the composition of the lithium metal complex oxide. Thus, it can be said that there is no difference at least in terms of the lithium metal complex oxide.

Further, from the results of Table 1 or the like, it was found that, when the minimum value of the powder crushing strength of the lithium metal complex oxide is more than 70 MPa, preferably 75 MPa or more, more preferably 80 MPa or more, and even more preferably 85 MPa or more, the capacity retention rate during high temperature cycles can be effectively increased. In this regard, it may be due to the reason that when the minimum value of the powder crushing strength is more than 70 MPa, disintegration of the particles can be suppressed even in a case where expansion and contraction of the positive electrode material occur during charging and discharging of the lithium secondary battery when it is used as a positive electrode material of a lithium secondary battery.

Meanwhile, the aforementioned Examples are related to the powder of lithium metal complex oxide with specific composition. However, it is not considered that the effect of enhancing the viscosity stability during storage of a slurry by defining the particle size and carbon amount per specific surface area is greatly affected by the composition of powder particles. Thus, it is believed that, with regard to the effect of enhancing the viscosity stability during storage of a slurry by defining the particle size and carbon amount per specific surface area, the same effect as Examples is obtained from all of the lithium metal complex oxides regardless of the composition.

Among them, so-called lithium rich lithium metal complex oxides in which a part of the metal elements constituting the lithium metal complex oxide is replaced with lithium have relatively high pH on a surface of the powder, and thus they have a common problem of easily increasing slurry viscosity. Thus, the aforementioned effect is particularly promising for them.

1. A lithium metal complex oxide having a D50 which is based on a volume-based particle size distribution as obtained by a laser diffraction scattering particle size distribution measurement method (referred to as “D50”) of less than 10 μm and a carbon amount per unit BET specific surface area of from 1100 ppm/(m²/g) to 7500 ppm/(m²/g).

2. The lithium metal complex oxide according to claim 1, which is represented by the general formula Li₁₊ₓM₁₋ₓO₂ (M: any one or more kinds of Mn, Co, Ni, a transition element present between the elements of Group 3 and the elements of Group 11 of the periodic table, and a typical element up to Period 3 of the periodic table).

3. The lithium metal complex oxide according to claim 1, which is obtained by a surface treatment using a coupling agent.

4. The lithium metal complex oxide according to claim 1, wherein the minimum value of a powder crushing strength obtained by crushing the powder using a micro compression tester is more than 70 MPa.

5. A lithium ion battery comprising the lithium metal complex oxide according to claim 1 as a positive electrode active material.

6. A lithium ion battery for a hybrid electric vehicle or an electric vehicle comprising the lithium metal complex oxide according to claim 1 as a positive electrode active material.

7. The lithium metal complex oxide according to claim 2, which is obtained by a surface treatment using a coupling agent.

8. The lithium metal complex oxide according to any one of claim 2, wherein the minimum value of a powder crushing strength obtained by crushing the powder using a micro compression tester is more than 70 MPa.

9. The lithium metal complex oxide according to any one of claim 3, wherein the minimum value of a powder crushing strength obtained by crushing the powder using a micro compression tester is more than 70 MPa.

10. A lithium ion battery comprising the lithium metal complex oxide according to any one of claim 2, as a positive electrode active material.

11. A lithium ion battery comprising the lithium metal complex oxide according to any one of claim 3, as a positive electrode active material.

12. A lithium ion battery comprising the lithium metal complex oxide according to any one of claim 4, as a positive electrode active material.

13. A lithium ion battery for a hybrid electric vehicle or an electric vehicle comprising the lithium metal complex oxide according to any one of claim 2, as a positive electrode active material.

14. A lithium ion battery for a hybrid electric vehicle or an electric vehicle comprising the lithium metal complex oxide according to any one of claim 3, as a positive electrode active material.

15. A lithium ion battery for a hybrid electric vehicle or an electric vehicle comprising the lithium metal complex oxide according to any one of claim 4, as a positive electrode active material.
